(19) United States
(12) Patent Application Publication
(10) Pub. No.: US 2014/0185229 A1
(43) Pub. Date: Jul. 3, 2014

(54) MOUNTING APPARATUS FOR DATA STORAGE DEVICE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: CHUNG CHAI, New Taipei (TW); ZHI-QIANG LI, Wuhan (CN); YI SHU, Wuhan (CN); TONG LI, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/053,819

(22) Filed: Oct. 15, 2013

(30) Foreign Application Priority Data
Dec. 28, 2012 (CN) 2012105820934

(51) Int. Cl. G06F 1/18

(52) U.S. Cl. CPC G06F 1/187
USPC 361/679.33; 312/333

(57) ABSTRACT

A mounting apparatus for mounting a data storage device includes a drive bracket and a locking member secured to the data storage device. The drive bracket includes a securing base, which defines a positioning hole and a pair of engaging holes. The locking member includes a positioning post and a pair of clasps. The positioning post is received in the positioning hole, and the clasps are received in the engaging holes to secure the data storage device in the drive bracket.

### BACKGROUND

1. Technical Field

The present disclosure relates to a mounting apparatus for securing a data storage device.

2. Description of Related Art

Many computers include data storage devices, such as hard disk drives or compact disc read-only memory (CD-ROM) drives. However, it may be inconvenient to secure the data storage devices and remove them from the computers. Therefore, a mounting apparatus that can easily secure the data storage devices to the computer system is needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a mounting apparatus for a data storage device.

FIG. 2 is similar to FIG. 1, but viewed from another aspect.

FIG. 3 is a partially assembled view of the mounting apparatus of FIG. 1.

FIG. 4 is an assembled view of the mounting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

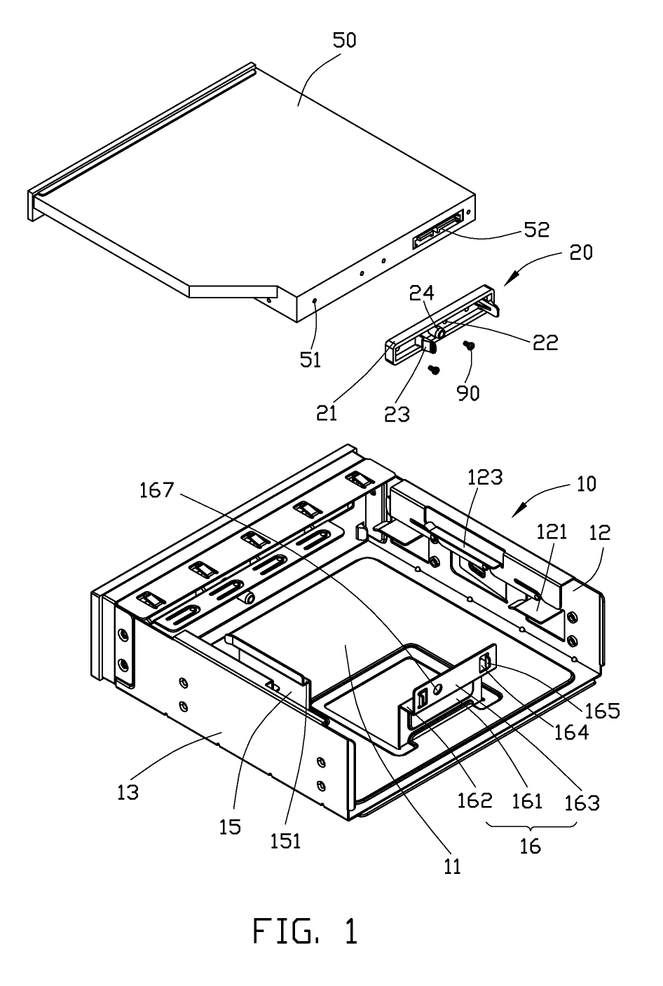

FIG. 1 shows that an embodiment of a mounting apparatus for a data storage device 50 includes a drive bracket 10 and a locking member 20. The data storage device 50 defines a plurality of securing holes 51 and a port 52. The data storage device 50 connects to other electronic devices through the port 52.

The drive bracket 10 includes a bottom plate 11, a first side plate 12, a second side plate 13, and a front plate 14. The first side plate 12 and the second side plate 13 are connected substantially perpendicularly to opposite side edges of the bottom plate 11. The front plate 14 is perpendicularly connected to a front edge of the bottom plate 11. The first side plate 12 is parallel to the second side plate 13. The front plate 14 defines an opening 141 for receiving the data storage device 50.

The first side plate 12 includes a pair of supporting pieces 121 extending substantially perpendicularly towards the second side plate 13. The first side plate 12 further includes a restricting piece 123 located between the pair of supporting pieces 121.

The bottom plate 11 further includes a supporting base 15 adjacent to the second side plate 13, and a securing base 16 adjacent to a rear edge of the bottom plate 11. The supporting base 15 includes a supporting wall 151, which is substantially parallel to the bottom plate 11. The supporting wall 151 and the pair of supporting pieces 121 are coplanar. The securing base 16 includes a connecting piece 161, a bent piece 162, and a securing piece 163. The connecting piece 161 is perpendicularly connected to the bottom plate 11. The bent piece 162 is perpendicularly connected to a top edge of the connecting piece 161. The securing piece 163 extends perpendicularly upward from a distal edge of the bent piece 162. The securing piece 163 defines a pair of engaging holes 164 and a positioning hole 167. The positioning hole 167 is defined between the pair of engaging holes 164. A protrusion 165 is formed at an edge of each engaging hole 164.

The locking member 20 includes a main body 21. The main body 21 defines a plurality of through holes 22 corresponding to the securing holes 51 of the data storage device 50. The main body 21 further includes a pair of clasps 23 and a positioning post 24. The clasps 23 are elastically bendable.

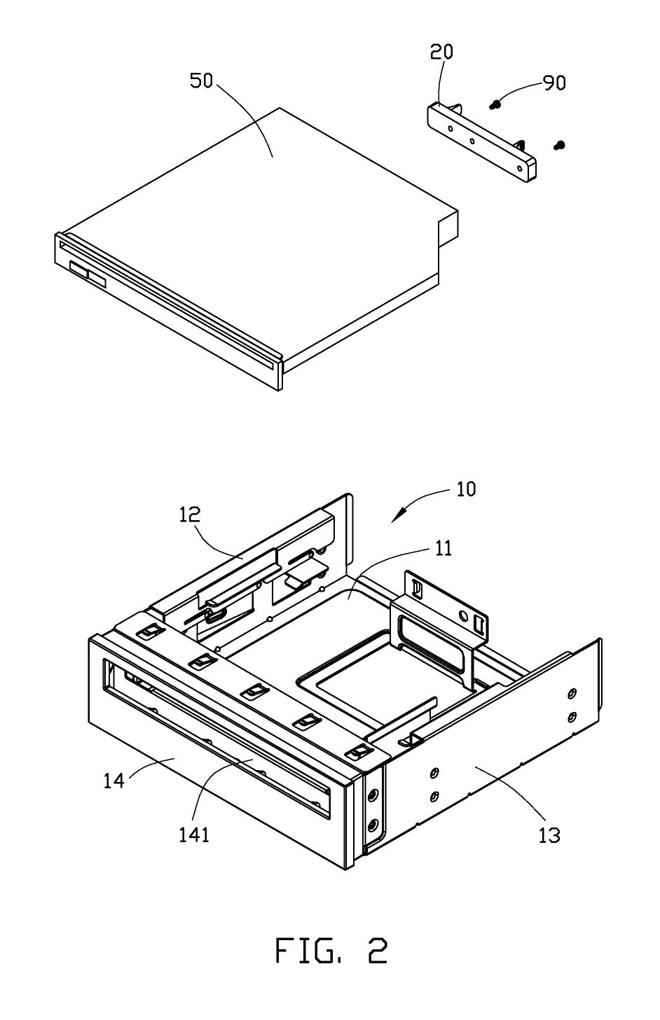

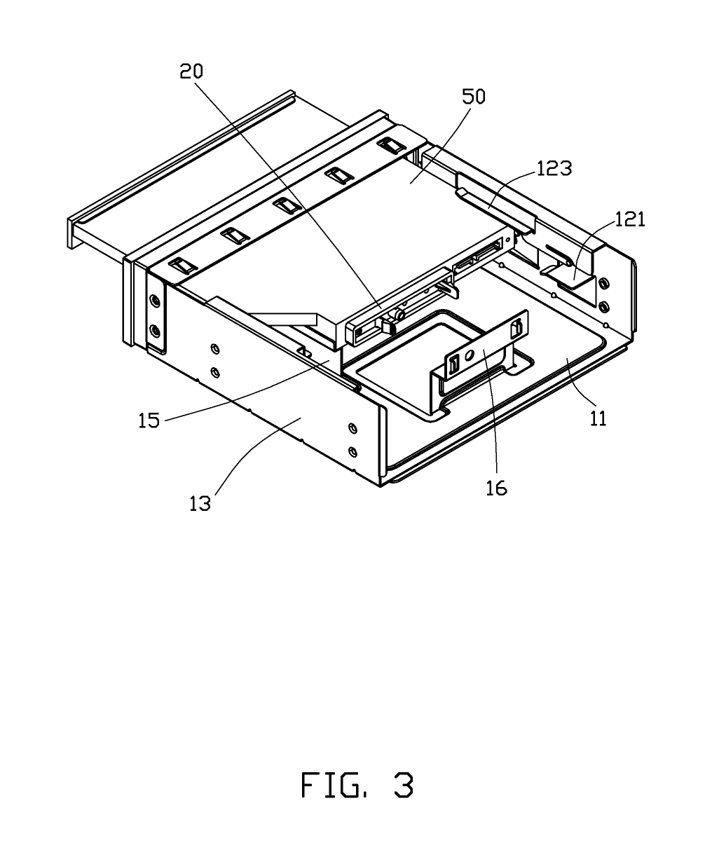

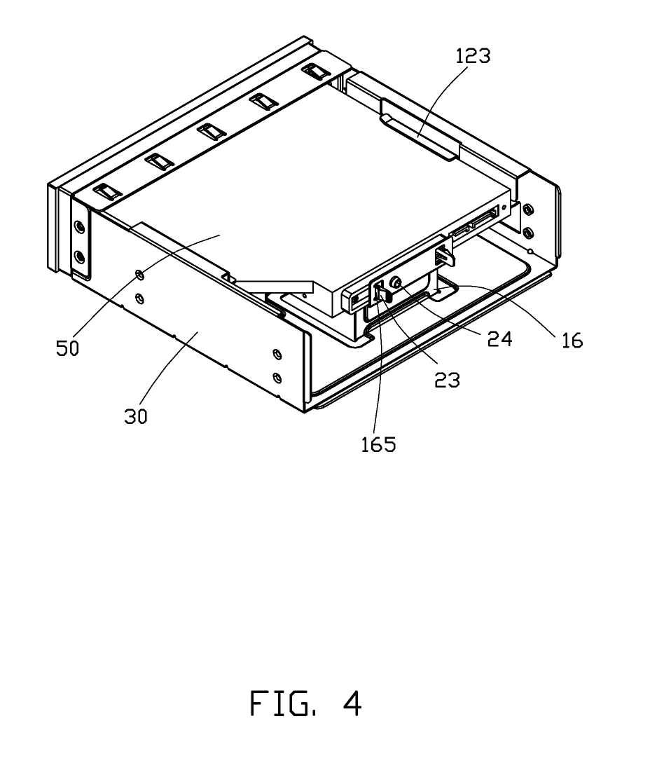

Referring to FIGS. 1 to 4, in assembly, the through holes 22 of the locking member 20 are aligned with the securing holes 51 of the data storage device 50. A plurality of fasteners 90 is received in the through holes 22 and the securing holes 51 to mount the locking member 20 to the data storage device 50. Then, the data storage device 50 is received in the drive bracket 10 via the opening 141. When the data storage device 50 is received in the drive bracket 10, the data storage device 50 is located on the supporting pieces 121, the supporting wall 151, and the bent piece 162. The restricting pieces 123 resist a top side of the data storage device 50. The positioning post 24 is received in the positioning hole 167 of the securing piece 163. Simultaneously, the clasps 23 are received in the engaging holes 164 to engage with the protrusions 165. Therefore, the data storage device 50 is securely mounted in the drive bracket 10.

To remove the data storage device 50 from the drive bracket 10, the clasps 23 are elastically bent to be disengaged from the protrusions 165, and the data storage device 50 is easily removed out of the drive bracket 10 from the opening 141.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A mounting apparatus for mounting a data storage device, comprising:
a drive bracket comprising a securing base which defines a positioning hole and an engaging hole; and
a locking member secured on the data storage device, the locking member comprising a positioning post and a clasp;
wherein the positioning post is configured to be inserted in the positioning hole, the clasp is configured to be engaged in the engaging hole, the clasp secures the data storage device in the drive bracket.

2. The mounting apparatus of claim 1, wherein the drive bracket comprises a front plate which defines an opening, the opening is configured so that the data storage device is removable from the drive bracket.

3. The mounting apparatus of claim 1, wherein the drive bracket comprises a first side plate, the first side plate comprises a supporting piece, and the supporting piece is configured to support the data storage device thereon.

4. The mounting apparatus of claim 3, wherein the first side plate further comprises a restricting piece, and the restricting piece is configured to press a top side of the data storage device.

5. The mounting apparatus of claim 1, wherein the drive bracket comprises a bottom plate, the bottom plate comprises a supporting base, the supporting base comprises a supporting wall, and the supporting wall is configured to support the data storage device thereon.

6. The mounting apparatus of claim 1, wherein the drive bracket comprises a bottom plate, and the securing base is located on the bottom plate.

7. The mounting apparatus of claim 6, wherein the securing base comprises a connecting piece and a bent piece, the connecting piece is connected to the bottom plate, the bent piece is connected to a top edge of the connecting piece, and the bent piece is configured to support the data storage device thereon.

8. The mounting apparatus of claim 7, wherein a securing piece extends perpendicularly and upwardly from a distal edge of bent piece, and the positioning hole and the engaging hole are defined in the securing piece.

9. The mounting apparatus of claim 7, wherein a protrusion is formed on an edge of the engaging hole, and the clasp is engaged with the protrusion.

10. An assembly, comprising:
a data storage device;
a locking member secured on the data storage device, the locking member comprising a clasp; and
a drive bracket comprising a securing base which defines an engaging hole, a protrusion formed on an edge of the engaging hole;
wherein the clasp is configured to be inserted in the engaging hole and engaged with the protrusion, the clasp mounts the data storage device in the drive bracket.

11. The assembly of claim 10, wherein the locking member comprises a positioning post, the securing base defines a positioning hole, and the positioning post is configured to be inserted in the positioning hole.

12. The assembly of claim 10, wherein the drive bracket comprises a front plate which defines an opening, the opening is configured so that the data storage device is removable from the drive bracket.

13. The assembly of claim 10, wherein the drive bracket comprises a first side plate, the first side plate comprises a supporting piece, and the supporting piece is configured to support the data storage device thereon.

14. The assembly of claim 13, wherein the first side plate further comprises a restricting piece, and the restricting piece is configured to press a top side of the data storage device.

15. The assembly of claim 10, wherein the drive bracket comprises a bottom plate, the bottom plate comprises a supporting base, the supporting base comprises a supporting wall, and the supporting wall is configured to support the data storage device thereon.

16. The assembly of claim 10, wherein the drive bracket comprises a bottom plate, the securing base is located on the bottom plate.

17. The assembly of claim 16, wherein the securing base comprises a connecting piece and a bent piece, the connecting piece is connected to the bottom plate, the bent piece is connected to a top edge of the connecting piece, and the bent piece is configured to support the data storage device thereon.

18. The assembly of claim 17, wherein a securing piece extends perpendicularly and upwardly from a distal edge of bent piece, and the engaging hole is defined in the securing piece.
